(19) United States
(12) Patent Application Publication
(10) Pub. No.: US 2013/0279639 A1
(43) Pub. Date: Oct. 24, 2013

(54) METHOD FOR DETECTING NUCLEAR MATERIAL BY MEANS OF NEUTRON INTERROGATION, AND RELATED DETECTION SYSTEM

(71) Applicants: Bertrand Perot, Venelles (FR); Cedric Carasco, Vinon-Sur-Verdon (FR)

(72) Inventors: Bertrand Perot, Venelles (FR); Cedric Carasco, Vinon-Sur-Verdon (FR)

(73) Assignee: COMMISSARIAT A L'ENERGIE ATOMIQUE ET AUX ENERGIES ALTERNATIVES, Paris (FR)

(21) Appl. No.: 13/978,097

(22) PCT Filed: Jan. 6, 2012
(86) PCT No.: PCT/EP2012/050163

§ 371 Date: Jul. 2, 2013

(30) Foreign Application Priority Data
Jan. 10, 2011 (FR) 11/50158

(51) Int. Cl. G01T 3/00

(52) U.S. Cl. CPC G01T 3/00
USPC 376/154

(57) ABSTRACT

A method for detecting nuclear material in an object analysed by neutron interrogation with an associated particle tube, where the method includes steps of detection of coinciding pulses by detector pixels of at least one matrix of detector pixels, where a step of detection of coinciding pulses leads to the formation of an event which reflects a fission reaction which occurs in the nuclear material, where the method includes a search for adjoining pixels amongst the pixels which have detected coinciding pulses, a grouping of adjoining pixels into groups of adjoining pixels, a count of the pixels and/or groups of adjoining pixels which have detected coinciding pulses, and a validation of the occurrence of an event provided at least three pixels and/or groups of adjoining pixels are counted.

### TECHNICAL FIELD AND PRIOR ART

The invention relates to a method for detecting nuclear material by neutron interrogation. The invention also relates to a system for detecting nuclear material which uses the method of the invention.

Nuclear material can be detected by conventional passive measurements, provided there is no shielding forming a screen, between the nuclear material and the detector making the measurements, against the neutron and gamma radiation emitted by the nuclear material. If the neutron emission is masked by shielding, active neutron interrogation systems must be envisaged such as, for example, detection by neutron interrogation.

Nuclear material detection by neutron interrogation is undertaken by provoking fission reactions in the nuclear material. Each fission reaction causes the simultaneous emission of several neutrons (typically 4 to 5 neutrons) and gamma radiation (typically 6 to 8 gamma photons). Neutrons and gamma radiation resulting from a fission reaction are detected coincidentally. Nuclear material is distinguished from non-nuclear material by the fact that a larger number of neutrons and gamma photons are emitted coincidentally than in the case of non-nuclear material. In addition, a time discrimination, implemented by the associated particle technique, enables coincidences due to fission particles to be distinguished from those due to non-nuclear materials.

The neutron and gamma photon detection devices of the known art are formed from detectors placed around the object to be inspected. The detectors are positioned close to one another to obtain satisfactory detection efficiency. An inconvenient phenomenon which appears during detection is the phenomenon of diaphony. Diaphony occurs when a neutron or a gamma photon detected in a first detector scatters into an adjoining detector, where it is also detected. This then causes a false coincidence, since two signals are detected, which do not correspond to two separate particles, but to a single particle.

Current solutions for resolving the problem of diaphony are:
moving the detectors further apart from one another,
establishing walls between the detectors, or again
systematic rejection of the coincidences for two adjoining detectors.

However, these solutions have many disadvantages. Moving the detectors further apart from one another reduces detection efficiency, due to the reduction in useful angular cover, which very greatly affects the probability of detecting the high-order coincidences. Establishing walls between the detectors also reduces the useful angular cover, since the separating walls are not suitable for detection. Furthermore, these walls increase the size and weight of the detection system. Finally, systematic rejection of the coincidences for two adjoining detectors substantially impairs detection efficiency.

Document WO 2007/144589 A2 discloses a high-energy radiation detector and the related method. The detector includes a matrix of detector pixels and an assembly of reading circuits which collect the charges detected by the detector pixels.

Document FR 2 945 631 A1 discloses the principle of analysing an object by neutron interrogation using an associated particle tube.

The detection method of the invention does not have the disadvantages mentioned above.

### ACCOUNT OF THE INVENTION

Indeed, the invention relates to a method for detecting nuclear material in an object by counting events which occur within the object following a neutron interrogation of the object for a duration ΔT, where the method includes multiple steps of detection of coinciding pulses by the associated particle technique, and where a step of detection of coinciding pulses by the associated particle technique is undertaken for a duration δT measured from a time reference associated with an instant of detection of an associated particle, characterised in that it includes, for each coinciding pulse detection:
an identification of detector pixels of at least one matrix of detector pixels which detect coinciding pulses,
a check that at least three coinciding pulses have been detected by three different detector pixels and, if so,
a search for adjoining pixels among the pixels which have detected coinciding pulses,
a classification of the pixels which have detected coinciding pulses in the form of isolated pixels and/or groups of adjoining pixels if adjoining pixels are identified,
a count of the isolated pixels and/or of the groups of adjoining pixels which have detected coinciding pulses,
a validation of occurrence of an event during duration δT if at least three isolated pixels and/or groups of adjoining pixels are counted in the step of counting the isolated pixels and/or groups of adjoining pixels,
   and in that it includes, for all the coinciding detections which occur:
a count of the number of validated events which occur above a time threshold counted from the time reference,
a determination of a shot noise detected above the time threshold,
a calculation of an alarm threshold on the basis of the shot noise,
a step of determination of a signal of the presence or absence of nuclear material in the object on the basis of a comparison of the number of validated events counted in the counting step with the alarm threshold, and
a calculation of a probability which reflects the rate of confidence which is associated with the signal of the presence or absence of nuclear material.

According to an additional characteristic of the invention, the shot noise detected above the time threshold is subtracted from the number of validated events which occur above the time threshold, such that the determination of the signal of the presence or absence of nuclear material in the object results from a comparison of the number of validated events counted in the counting step, minus the shot noise with the alarm threshold.

According to another additional characteristic of the invention, the step of counting the validated events which occur above a time threshold counted from the time reference is a step of formation of a histogram.

According to yet another additional characteristic of the invention, duration ΔT is predetermined in advance, such that the counting of the number of validated events which occur above a time threshold, the determination of the shot noise, the calculation of the alarm threshold and the step of determination of the signal of the presence or absence of nuclear material are implemented once duration ΔT is completed.

According to yet another additional characteristic of the invention, the counting of the number of validated events which occur above a time threshold, the determination of the shot noise, the calculation of the alarm threshold and the step of determination of the signal of the presence or absence of nuclear material are implemented as the successive coinciding detections occur.

The invention also relates to a detection system which uses the method of the invention.

Major advantages of the detection method of the invention are that it is able to cover a maximum detection solid angle, and that it does not reject an event when adjoining detectors are activated. This thus enables the detection performance to be maximised compared to the methods of the prior art.

### BRIEF DESCRIPTION OF THE FIGURES

Other characteristics and advantages of the invention will appear on reading a preferential embodiment made in reference to the attached figures, among which:

FIG. 1 represents the outline diagram of a first example of a detection system able to implement the method of the invention;

FIG. 2 represents the outline diagram of a second example of a detection system able to implement the method of the invention;

FIG. 3 represents a flow chart for validating events which is implemented by the detection method of the invention;

FIG. 4 illustrates, as an example, detection of particles by detector pixels of a detection system which implements the method of the invention;

FIG. 5 represents a flow chart of a first variant of the detection method of the invention;

FIG. 6 represents the formation of a histogram obtained in the context of the detection method of the invention;

FIG. 7 represents a flow chart of a second variant of the detection method of the invention.

### DETAILED ACCOUNT OF A PREFERENTIAL EMBODIMENT OF THE INVENTION

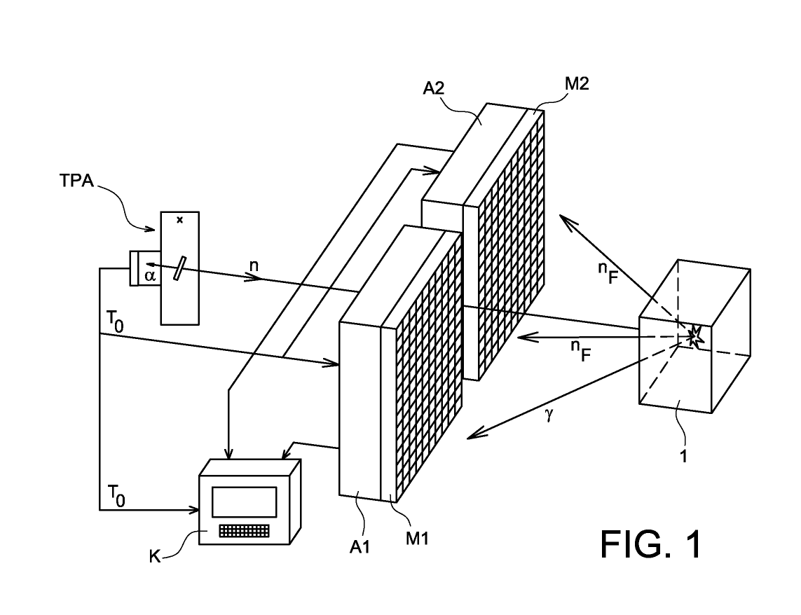

FIG. 1 represents the outline diagram of a first example of a detection system able to implement the method of the invention;

The detection system includes:
an associated particle tube TPA which emits fast neutrons n in the direction of object 1 to be inspected,
a detector structure consisting of two matrices of detector pixels M1, M2, able to detect neutrons n_{F} and gamma photons γ which are emitted by object 1,
a system for acquiring the signals delivered by the matrices of detector pixels consisting, in a manner known per se, of two electronic data acquisition units A1, A2, associated respectively with matrices of detector pixels M1, M2, and
a computer K which processes the signals delivered by the acquisition system.

In the associated particle tube, an α particle is emitted simultaneously with the emission of a fast neutron n. It is known, furthermore, that the α particle is emitted in a direction opposite the direction in which the fast neutron is emitted. It follows that the detection of the α particle associated with a fast neutron provides information of the instant at which the fast neutron is emitted, and of the direction in which this neutron is emitted. The fast neutron is thus “signed” by the α particle associated with it. In the remainder of the description, the fast neutrons emitted by the associated particle tube will therefore also be called “signed” fast neutrons.

The detector pixels of each of the two matrices are contiguous. The detector pixels are preferentially organic scintillation detectors. The size of each detector pixel is dimensioned such that each detector pixel is able to detect efficiently, by itself alone, fission neutrons and gamma photons. The matrices of pixels M1, M2 are placed side-by-side, at a small distance from one another, and have a detector surface facing object 1 to be inspected. The detector surfaces define a single detection surface interrupted only by the narrow space separating the matrices, a space which allows the interrogator neutrons signed n emitted by tube TPA to pass.

Associated particle tube TPA and object 1 to be inspected are preferentially placed either side of the detector structure consisting of the two matrices M1, M2. Optimisation of the area and thickness of detection matrices M1, M2, and optimisation of the size of the pixels, depend both on physical parameters (average interaction length of the neutrons and gamma radiation in the scintillator, detection efficiency, etc.), and on operational constraints such as portability (weight, volume) and the cost of the system (number of measuring channels).

Associated particle tube TPA emits a succession of interrogator neutrons signed n in direction of object 1. The trajectory of neutrons n passes through the space separating the two matrices of pixels before reaching object 1. When a signed neutron reaches object 1, a nuclear fission reaction occurs in this object if it contains nuclear material. The nuclear fission reaction produces fast neutrons n_{F} and gamma rays γ which are detected by matrices M1, M2. The pulses arising from the detection of the fast neutrons and of the gamma rays are processed by electronic data acquisition units A1, A2 and computer K. As has previously been mentioned, by the associated particle technique, an α particle is detected by tube TPA when a fast neutron n is emitted. The instant of detection of the α particle thus enables a reference instant Tₒ to be defined from which the detection instants of the fission neutrons and gamma photons are counted. This reference instant Tₒ is a parameter which is applied to electronic data acquisition units A1, A2 and to computer K.

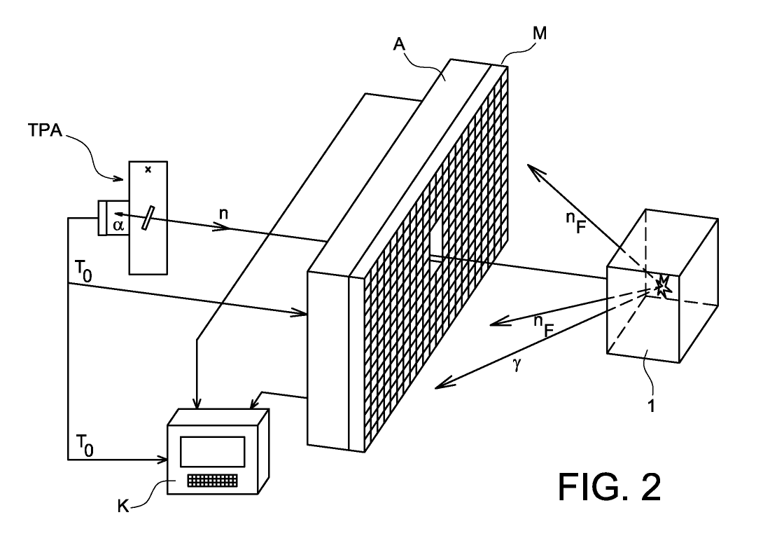

FIG. 2 represents the outline diagram of a second example of a detection system able to implement the method of the invention. In the example of FIG. 2 the detection system includes only a single matrix M, which matrix M is associated with a single electronic data acquisition unit A. An aperture O is made in matrix M and in acquisition electronic unit A to allow fast neutrons n emitted by the TPA in direction of object 1 to pass. The aperture made in matrix M has the dimensions of at least one detector pixel. The aperture is preferentially centred relative to the detector surface presented by matrix M.

The detection systems represented in FIGS. 1 and 2 are preferential embodiments of the invention. The invention relates, however, to other embodiments such as, for example, a system which includes a single full detector matrix (a “full” matrix is understood to mean a matrix without apertures), off-centre relative to the axis of propagation of fast neutrons n (this then corresponds to the case of FIG. 1, in which one of the two matrices M1, M2 is absent), or again a system which includes at least three matrices separated from one another (this corresponds to the case of FIG. 1, in which at least one additional matrix is present, next to matrices M1, M2, to enlarge the detection plane).

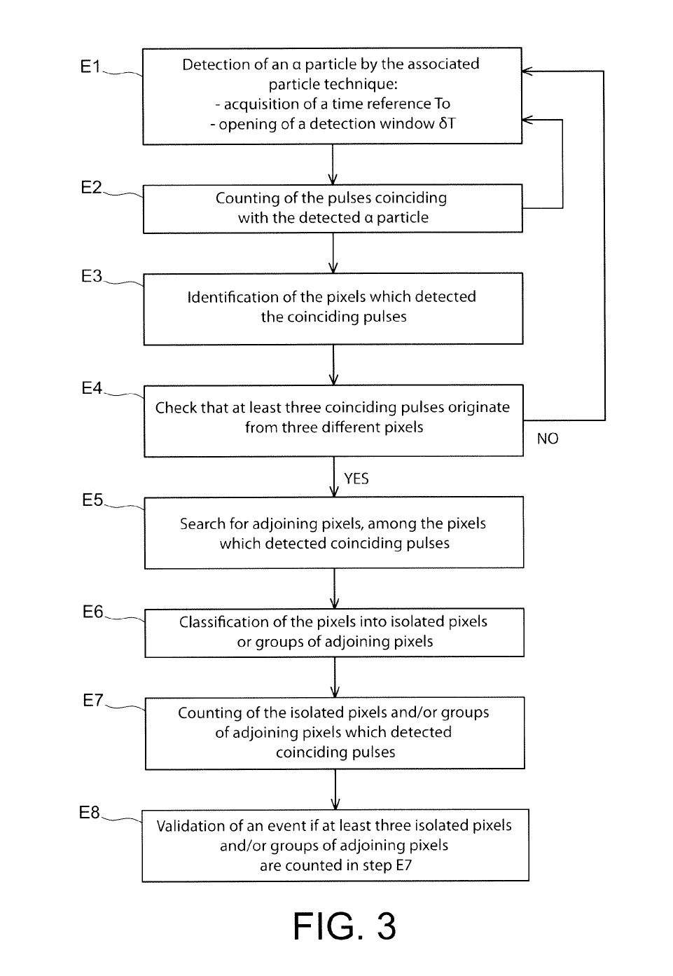

FIG. 3 represents the flow chart of a method for validating events which is implemented by the detection method of the invention.

The event validation method includes the following steps in succession:
a step E1 of a particle detection by the associated particle technique, where the detection of the α particle leads to the acquisition of reference time Tₒ, which triggers the opening of a time window δT for detecting coincidences,
a step E2 of counting pulses coinciding with the detected α particle,
a step E3 of identification of the pixels of the detection system which have delivered the coinciding pulses,
a step E4 which consists in checking whether or not at least three coinciding pulses derive from three different detector pixels and, if so,
a step E5 of searching for adjoining pixels among the pixels which have delivered coinciding pulses,
a step E6 of classification of the pixels which have detected coinciding pulses in the form of isolated pixels and/or groups of adjoining pixels found in step E5,
a step E7 of counting the isolated pixels and/or groups of adjoining pixels which have detected coinciding pulses, and
a step E8 of validating an event once at least three isolated pixels and/or groups of adjoining pixels are counted in step E7.

In the context of the invention, two pixels of a pixel matrix are said to be “adjoining” if they have a given side or a given corner in common. When the system of the invention includes two pixel matrices placed side-by-side, a column of pixels of the first matrix is facing a column of pixels of the other matrix. Each pixel of a column of pixels is then adjoining, for the pixel matrix to which it belongs, to a pixel according to the rule mentioned above and, for the pixel matrix positioned opposite, to any pixel in the facing column of pixels. When the invention relates to a pixel matrix having an aperture, each pixel on the edge of the aperture is adjoining to a pixel of the matrix according to the rule mentioned above and, in addition, to all the other pixels on the edge of the aperture, except for the pixels with which it is aligned, which are located beyond the pixel or pixels which are adjacent to it. Similarly, in the context of the invention, a pixel is said to be “isolated” if it detects a pulse without any of the pixels adjoining to it detecting a pulse.

Preferentially, when an event is validated, whether it includes pulses derived from isolated pixels and/or groups of adjoining pixels, instant T₁ which is associated with the validated event, counted from instant Tₒ, is defined arbitrarily as the instant when a first pulse is detected.

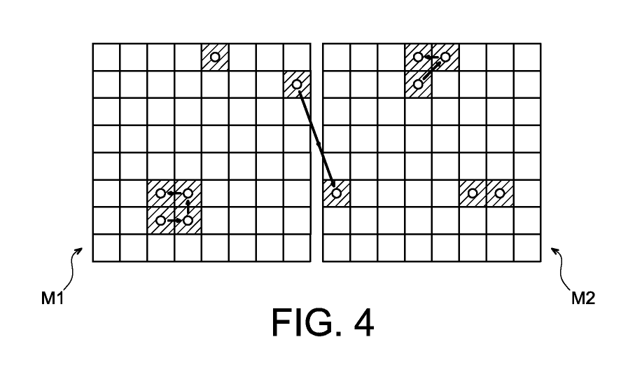

FIG. 4 illustrates, as a non-restrictive example, a detection of particles by detector pixels of the detection system represented in FIG. 1.

All the detected particles (neutrons and/or gamma rays) are particles coinciding with an α particle. Matrices M1, M2 are, for example, 8×8 matrices. More generally, however, the matrices used in the context of the invention are I×J matrices, where I and J are integers of any value. The pixels of matrix M1 are referenced Xᵢⱼ (pixel of the line of row i and of the column of row j) and the pixels of matrix M2 are referenced Y₁ (pixel of the line of row i and of the column of row j).

In matrix M1:
a given particle is firstly detected in pixel X₇₃, and then in pixels X₇₄, X₆₄, X₆₃,
a particle is detected in pixel X₁₄, and
a particle is detected in pixel X₂₈.

In matrix M2:
a given particle is firstly detected by pixel Y₂₄, and then by pixels Y₁₅ and Y₁₄,
a particle is detected by pixel X₆₆.
a particle is detected by pixel X₆₇, and
the particle detected in pixel X₂₈ is also detected in pixel Y₃₁.

In the case of matrix M1, it is then considered that a particle is detected by pixel X₁₄ and that a single particle is detected by pixels X₇₃, X₇₄, X₆₄ and X₆₃. In the case of matrix M2, it is considered that a single particle is detected by pixels Y₂₄, Y₁₅ and Y₁₄ and that a single particle is detected by pixels Y₆₆ and Y₆₇. In the case of matrices M1 and M2 viewed simultaneously, it is considered that a single particle is detected by pixels X₂₈, and Y₆₁.

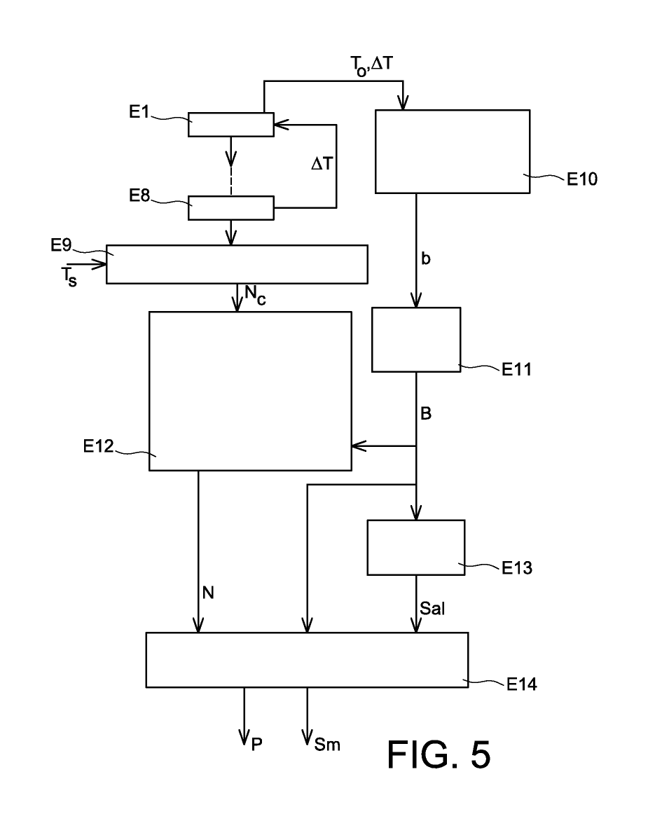

FIG. 5 represents a flow chart of a first variant of the detection method of the invention.

Steps E1-E8 mentioned above are repeated for a duration ΔT determined in advance, for example equal to 10 minutes. The number N_{c} of validated events which occur, over the whole of duration ΔT, beyond a time threshold Tₛ, is then counted (step E9). Time threshold Tₛ defines an instant below which it is considered that most of the events having arisen are not fission reactions which occur in nuclear material. Most of the events having occurred below instant Tₛ are then considered to be due to reactions which occur in the non-fissile materials which surround the nuclear material, such as, for example, inelastic scattering reactions (n, n′γ). Indeed, although nuclear material is present in the analysed object, the latter is, in fact, concealed in packages of benign appearance (packets, luggage, transport containers, etc.) and it is, in addition, surrounded by specific materials intended to form effective screens against neutron and gamma radiation such as, for example, polythene, iron or lead. In the case of these materials, due to the multiple gamma and neutron rays which they may emit simultaneously following their interaction with a signed neutron, the number of hits detected is often very high at instants close to instant Tₒ and, although events genuinely due to fission reactions may be detected before instant Tₛ, the risk of a false alarm would be much higher if these events were taken into account. Depending on the dimensions of the inspected object and on the distance between the detector pixels and the inspected object, a time threshold Tₛ is therefore defined, counted from time Tₒ, below which the events are not taken into account.

Simultaneously with the repetition of steps E1-E8, measurements of random noise b present outside acquisition windows δT are made (step E10). These measurements of random noise b are made, for example, in a manner known per se, over time intervals which precede instants Tₒ (“negative” times). From the measurements of noise b, noise B which is present, beyond successive instants Tₛ, over the whole of duration ΔT is then determined (step E11).

On conclusion of steps E9 and E11, i.e. at the end of duration ΔT, a step E12 subtracts noise B from the N_{C} events counted in step E9. Step E12 results in a number N of validated events.

Simultaneously with step E12 which calculates number N of validated events, a step E13 of calculation of an alarm threshold Sₐ₁ occurs. Alarm threshold Sₐ₁ is calculated from the value of noise B as being equal, for example, to twice the standard deviation of noise B. Number N of validated events is then compared with alarm threshold Sₐ₁.

By comparing N and Sₐ₁, a signal Sₘ is obtained which indicates the presence (if Sₐ₁≦N) or absence (if Sₐ₁>N) of nuclear material. Signal Sₘ is accompanied by a probability P which expresses the level of confidence with which the presence or absence of nuclear material must be considered, i.e. the risk of a false alarm when the presence of nuclear material is announced, and that of non-detection when an absence of nuclear material is announced. Probability P is calculated, in a manner known per se, from N and from noise B.

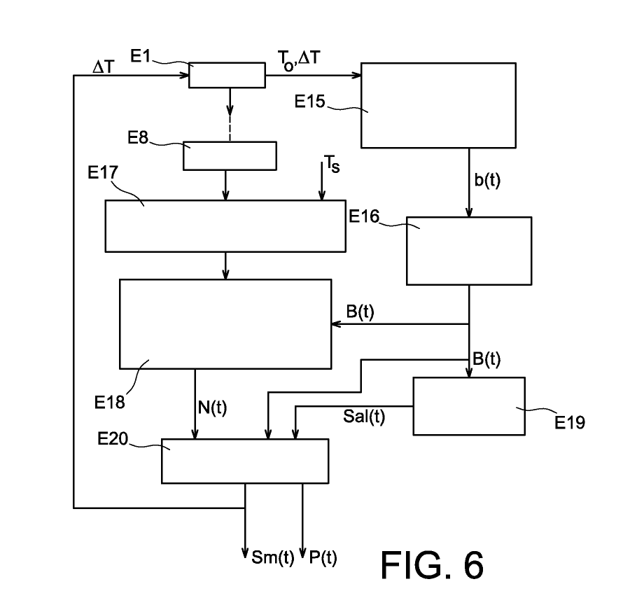

FIG. 6 represents a flow chart of a second variant of the detection method of the invention.

According to the second variant of the detection method of the invention, duration ΔT is not determined in advance, and the comparison with the alarm threshold of the number of validated events counted which occur beyond successive instants Ts is made as detections which occur in the successive acquisition windows are made. In this case, the steps E17, E15, E16, E18, E19 and E20, implemented over time as the successive detections are made, correspond respectively to the steps E9, E10, E11, E12, E13 and E14 of the first variant of the method of the invention implemented over the whole predetermined duration ΔT.

Step E18 results, in real time, in a number N(t) of counted noise-free events being obtained which may correspond to fission reactions occurring in nuclear material. An alarm threshold Sₐ₁(t) is calculated from noise B(t) in step E19. Number N(t) is then compared with alarm threshold Sₐ₁(t) in step E20. E20 results in a signal Sₘ(t) which reflects the presence or absence of nuclear material and a probability P(t) which reflects the level of confidence with which signal Sₘ(t) must be considered. While number N(t) remains less than Sₐ₁(t), signal Sₘ(t) indicates that there is no nuclear material in the object and new validation steps are undertaken. As soon as number N(t) reaches alarm threshold Sₐ₁(t), signal Sₘ(t) signals the presence of nuclear material, and probability P(t) gives the rate of confidence associated with this information. Counting is then discontinued. Counting may also be continued, on a decision of the operator, to evaluate the change in the rate of confidence which is associated with the information concerning the presence of nuclear material. Conversely, when signal Sₘ(t) indicates that there is no nuclear material and that the rate of confidence associated with this information concerning the absence of nuclear material is high for a substantial duration, it is suggested to the operator that they discontinue counting.

According to the first and second variants of the method of the invention described above, the determination of the signal concerning the presence or absence of nuclear material results from a comparison of the number of validated events which occur above time threshold Tₛ with the alarm threshold, where the number of validated events and the alarm threshold are each reduced by shot noise B. In another embodiment of the invention, the determination of the signal concerning the presence or absence of nuclear material results from a comparison of the number of validated events which occur above time threshold T_{S} with the shot noise, without these values being reduced by the shot noise. A comparison of number N_{C} of events and of the alarm threshold also leads to a signal being obtained which indicates the presence or absence of nuclear material in the inspected object. The probability with which the obtained signal must be considered is also calculated.

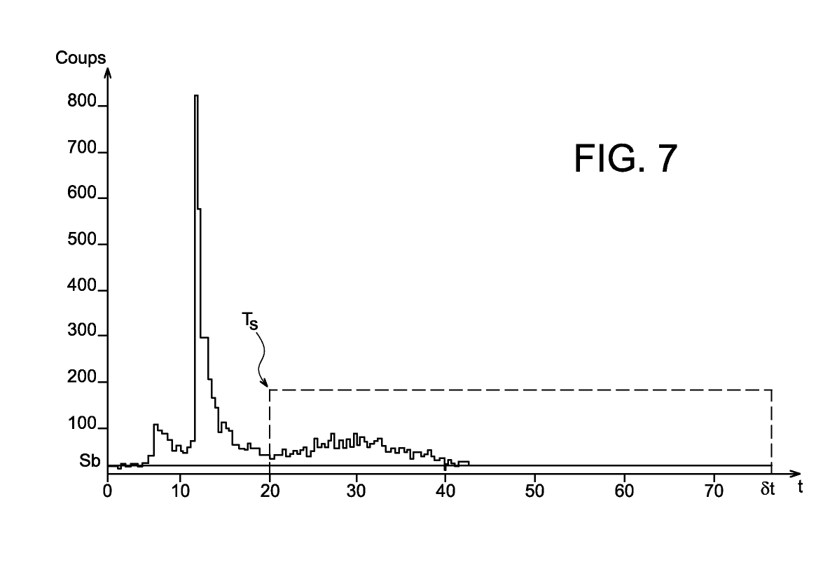

FIG. 7 represents, as an example, a histogram obtained according to the preferential embodiment of the invention.

The step of counting the validated events is in this case a step of formation of the histogram of all the validated events which occur during duration ΔT. As was previously mentioned, each event is positioned, in the histogram, by an instant T₁ counted from instant Tₒ. Of the validated events only events located beyond instant Tₛ are counted. Duration δt of the acquisition window is, for example, equal to 76 ns and time Tₛ is, for example, equal to 20 ns. Detection of a large number of hits below threshold Tₛ can be seen clearly in FIG. 7. The histogram of FIG. 7 includes the noise events (noise level Sb) the accumulation of which over interval ΔT is the measurement of noise B mentioned above.

1. A method for detecting nuclear material in an object on the basis of a count of events occurring in the object following a neutron interrogation of the object for a duration ΔT, where the method includes multiple steps of detection of coinciding pulses using an associated particle tube (E1, E2), in which an associated particle is emitted simultaneously with the emission of a fast neutron, in a direction opposite the direction in which the fast neutron is emitted, where a step of detecting coinciding pulses is performed for a duration δT counted from a time reference (Tₒ) associated with an instant of detection of an associated particle, characterised in that it includes, for each detection of coinciding pulses:
an identification (E3) of detector pixels of at least one matrix of detector pixels which detect coinciding pulses,
a check (E4) that at least three coinciding pulses have been detected by three different detector pixels and, if so,
a search for adjoining pixels (E5) among the pixels which have detected coinciding pulses,
a classification (E6) of the pixels which have detected coinciding pulses in the form of isolated pixels and/or groups of adjoining pixels if adjoining pixels are identified,
a count (E7) of the isolated pixels and/or of the groups of adjoining pixels which have detected coinciding pulses,
a validation of occurrence of an event (E8) during duration δT if at least three isolated pixels and/or groups of adjoining pixels are counted in the step of counting the isolated pixels and/or groups of adjoining pixels,
and in that it includes, for all the coinciding detections which occur:
a count (E9) of the number of validated events which occur above a time threshold (Tₛ) counted from the time reference (Tₒ),
a determination of a shot noise (E10, E11) detected above the time threshold (Tₛ),
a calculation of an alarm threshold (Sₐ₁) on the basis of the shot noise (B),
a step of determination of a signal (Sₘ) of the presence or absence of nuclear material in the object on the basis of a comparison (E15) of the number of validated events counted in the counting step (E9) with the alarm threshold, and
a calculation of a probability (P) which reflects the rate of confidence which is associated with the signal (Sₘ) of the presence or absence of nuclear material.

2. A detection method according to claim 1, in which the shot noise detected above the time threshold (Tₛ) is subtracted from the number of validated events which occur above the time threshold (Tₛ), such that the determination of the signal of the presence or absence of nuclear material in the object results from a comparison of the number of validated events counted in the counting step, minus the shot noise with the alarm threshold.

3. A detection method according to claim 1, in which the step (E9) of counting the validated events which occur above a time threshold (Tₛ) counted from the time reference (Tₒ) is a step of formation of a histogram.

4. A detection method according to claim 1, in which duration ΔT is predetermined in advance, such that the counting of the number of validated events which occur above a time threshold, the determination of the shot noise, the calculation of the alarm threshold and the step of determination of the signal of the presence or absence of nuclear material are implemented once duration ΔT is completed.

5. A detection method according to claim 1, in which the counting of the number of validated events which occur above a time threshold, the determination of the shot noise, the calculation of the alarm threshold and the step of determination of the signal of the presence or absence of nuclear material are implemented as the successive coinciding detections occur.

6. A system for detecting nuclear material in an object (1) on the basis of a count of events occurring in the object following a neutron interrogation of the object for a duration ΔT, where the system includes an associated particle tube (TPA) which emits neutrons (n) in the direction of the object, and at least one matrix of detector pixels (M1, M2) able to detect coinciding pulses using an associated particle tube, in which an associated particle is emitted simultaneously with the emission of a fast neutron, in a direction opposite the direction in which the fast neutron is emitted, where a step of detecting coinciding pulses is performed for a duration δT counted from a time reference (Tₒ) associated with an instant of detection of an associated particle, characterised in that it includes:
means (E3) of identifying detector pixels which detect coinciding pulses,
means (E4) to check that at least three coinciding pulses have been detected by three different detector pixels,
means (E5) to seek adjoining detector pixels, among the pixels which have detected coinciding pulses, if at least three coinciding pulses have been detected by three different detector pixels,
means (E6) of classifying the pixels which have detected coinciding pulses in the form of isolated pixels and/or groups of adjoining pixels if adjoining pixels are identified,
means (E7) of counting the isolated pixels and/or of the groups of adjoining pixels which have detected coinciding pulses,
means (E8) of validating the occurrence of an event during duration δT if at least three isolated pixels and/or groups of adjoining pixels are counted in the step of counting the isolated pixels and/or groups of adjoining pixels,
means (E9) of counting the number of validated events which occur overall during duration ΔT above a time threshold (Tₛ) counted from the time reference (Tₒ),
means (E10, E11) of determining a shot noise detected, during duration ΔT, above the time threshold (Tₛ),
means (E14) of calculating an alarm threshold (Sₐ₁) on the basis of the shot noise (B),
means of determining a signal (Sₘ) of the presence or absence of nuclear material in the object on the basis of a comparison (E15) of the number of validated events counted by the means of counting the validated events with the alarm threshold, and
means for calculating a probability (P) which reflects the rate of confidence which is associated with the signal (Sₘ) of the presence or absence of nuclear material.

7. A system according to claim 6, in which two matrices of detector pixels (M1, M2) are positioned side-by-side, where a column of pixels of a first matrix (M1) is facing a column of pixels of the second matrix, where the detector surfaces of both matrices are positioned in the same plane opposite the object, where the trajectory of the neutrons (n) which are emitted by the associated particle tube (TPA) passes through the space separating the two matrices of detector pixels, where two adjoining pixels of a given matrix are pixels which have a given side or a given corner in common and where every pixel of the column of pixels of the first matrix, respectively of the second matrix, is an adjoining pixel for every pixel of the column of pixels of the second matrix, respectively of the first matrix.

8. A system according to claim 6, in which a detection matrix (M) is positioned on the trajectory of the neutrons (n) which are emitted by the associated particle tube (TPA), where the detection matrix has an aperture (O) able to allow the neutrons to pass, where two adjoining pixels of the matrix are pixels which have a given side or a given corner in common, where every pixel at the edge of the aperture (O) is a pixel which is adjoining to every other pixel at the edge of the aperture, except for the pixels with which it is aligned, and which are located beyond the pixel or pixels which are adjacent to it.

9. A system according to claim 6, in which the detector pixels are organic scintillators.
